(19) United States
(12) Patent Application Publication
(10) Pub. No.: US 2026/0291375 A1
(43) Pub. Date: Sep. 24, 2026

(54) POWER PROTECTING DEVICE AND CONTROLLING METHOD THEREOF

(71) Applicant: AcLeap Power Inc., Taipei City (TW)

(72) Inventors: Xuehui Dai, Shanghai City (CN); Terry Zhang, Shanghai City (CN); Rongjun Deng, Shanghai City (CN); Tom Sun, Shanghai City (CN); Hardy Huang, Shanghai City (CN)

(21) Appl. No.: 19/282,321

(22) Filed: Jul. 28, 2025

(30) Foreign Application Priority Data
Mar. 19, 2025 (CN) 202510329050.2

(51) Int. Cl. H02M 1/34; H02M 1/32; H02M 1/44

(52) U.S. Cl. CPC H02M 1/344; H02M 1/327; H02M 1/44

(57) ABSTRACT

The disclosure discloses a power protecting device. The power protecting device comprises an input power source coupled to a first capacitor at a first node, configured to provide an input voltage signal; a first switch coupled to the first capacitor; a first resistor coupled to the first capacitor and connected in parallel with the first switch; and an absorber circuit coupled to the first node or coupled to the first node through the first capacitor, wherein the absorber circuit is coupled between the input power source and the first switch, and the absorber circuit is connected in parallel with each of the first switch and the first resistor, or the absorber circuit is coupled to the first capacitor, the first switch and the first resistor, and the absorber circuit is connected in parallel with a combo of the first capacitor, the first switch, and the first resistor.

### PRIORITY

This application claims priority to China Application Serial Number 202510329050.2, filed on Mar. 19, 2025, which is herein incorporated by reference.

### BACKGROUND

In order to achieve a higher efficiency for power converting device of an electrical system, a topology of connecting a bus capacitor to a powering switch in series at the input terminal of the power converting device is adopted to establish an anti-inrush circuit. At the initial powering stage, the powering switch connecting in series to the bus capacitor is turned off, such that the bus capacitor can only be charged through a high resistant loop which further avoid the generation of higher inrush current at the input terminal caused by transiently charging of the bus capacitor. However, in response to the powering switch being turned off, the bus capacitor is placed at a high resistant path, resulting in the loss of a clamping ability toward a transient voltage. The transient voltage surge generated on the bus is unable to be suppressed effectively. As a result, an intervention of a specific power protecting device implemented into the circuit is demanded to satisfy the technical requirement of the bus voltage clamping protection.

### SUMMARY

The present disclosure provides a power protecting device. The power protecting device comprises an input power source coupled to a first capacitor at a first node, and configured to provide an input voltage signal; a first switch coupled to the first capacitor; a first resistor coupled to the first capacitor, and connected to the first switch in parallel; and an absorber circuit coupled to the first node, or coupled to the first node through the first capacitor, wherein, the absorber circuit is coupled between the input power source and the first switch, and the absorber circuit is connected in parallel with each of the first switch and the first resistor, or the absorber circuit is coupled to the first capacitor, two terminals of the first switch and two terminals of the first resistor, and the absorber circuit is connected in parallel with a combo of the first capacitor, the first switch, and the first resistor.

The present disclosure provides a method for controlling a power protecting device. The method comprises coupling a first capacitor to an input power source at a first node; coupling a first switch to the first capacitor; when a voltage level of a voltage signal at the first node is higher than or equal to a turn-on voltage level of a second switch, turning on the second switch; and when the second switch is turned on, and when a current level of a second current signal flowed through the second switch is lower than a holding current level, turning off the second switch, wherein the input power source is configured to provide a first current signal, the first current signal flows through each of the first node and the first capacitor.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a circuit diagram of a power protecting device, illustrated in accordance with some embodiments of the present disclosure.

FIG. 2 is a circuit diagram of an absorber circuit, illustrated in accordance with some embodiments of the present disclosure.

FIG. 3 is a circuit diagram of an absorber circuit, illustrated in accordance with some embodiments of the present disclosure.

FIG. 4 is a circuit diagram of a power protecting device, illustrated in accordance with some embodiments of the present disclosure.

FIG. 5 is a timing diagram of operating a power protecting device, illustrated in accordance with some embodiments of the present disclosure.

FIG. 6A is a circuit diagram of operating a power protecting device during a period in the timing diagram of FIG. 5, illustrated in accordance with some embodiments of the present disclosure.

FIG. 6B is a circuit diagram of operating a power protecting device during a period in the timing diagram of FIG. 5, illustrated in accordance with some embodiments of the present disclosure.

FIG. 6C is a circuit diagram of operating a power protecting device during a period in the timing diagram of FIG. 5, illustrated in accordance with some embodiments of the present disclosure.

FIG. 7 is a flow chart diagram of a control process controlling a power protecting device, illustrated in accordance with some embodiments of the present disclosure.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The following disclosure provides a method of protecting for a power system. The method can provide protection for high transient voltage at the input of a power system due to inrush current caused by input capacitors during initial operation of power supply. In addition, the method also has an effective suppression performance on the transient voltage surge from the input of the power system caused by lightning. Furthermore, the method has a self-recoverability which allows the protection function of device to return to its initial state after the voltage pulse has subsided and can provide continuous protection. The following disclosure combines the voltage absorber circuit and controlled transfer switch to promote the reliability and stability of the power system. In some embodiment, the power system can be embodied by a power converter.

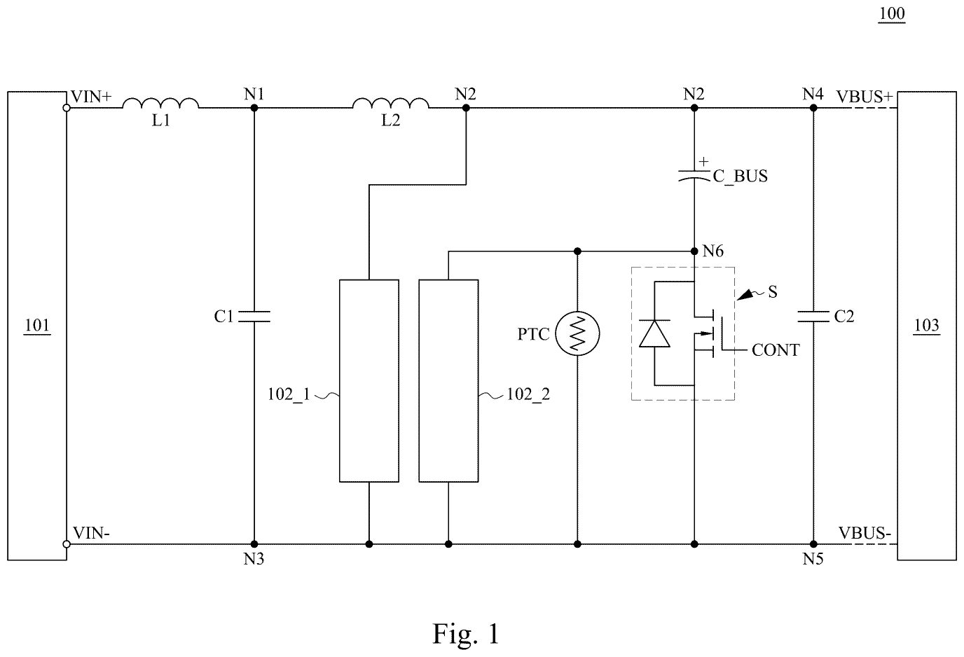

FIG. 1 is a circuit diagram of a power protecting device 100, illustrated in accordance with some embodiments of present disclosure. As shown in FIG. 1, the power protecting device 100 includes an input power source 101, a load 103, a resistor PTC, an inductance L1, an inductance L2, a switch S, capacitors C1, C2, and C_BUS. In some embodiments, the power protecting device 100 is configured to provide an input voltage signal VIN by the input power source 101, and is configured to generate a voltage signal V_BUS provided to the load 103 according to the input voltage signal VIN.

In some embodiments, the power protecting device 100 further includes an absorber circuit which is configured to suppress a transient voltage surge. The power protecting device 100 can include one of an absorber circuits 102_1 and 102_2, or both of the absorber circuits 102_1 and 102_2.

In some embodiments, the resistor PTC has different resistant value according to the change of body temperature of the resistor PTC itself.

In some embodiments, the load 103 can be a direct current to direct current (DC-DC) converter or other similar devices or elements, but the present disclosure is not limited to the device mentioned above.

In some embodiments, the capacitor C1 is configured to filter voltage signals at two terminals of the input power source 101 to reduce electromagnetic interference. In some embodiments, the capacitor C2 is configured to filter voltage signals of front-end circuitry of the load 103. In some embodiments, the capacitor C_BUS is configured to store energy and suppress the transient voltage surge.

As illustratively shown in FIG. 1, two terminals of the input power source 101 are configured to provide input voltages VIN+ and VIN− , respectively. The power protecting device 100 is configured to provide voltages VBUS+ and VBUS− to two terminals of the load 103, respectively, according to each of the input voltages VIN+ and VIN−. In some embodiments, two terminals of the input power source 101 have a voltage difference being equal to the input voltage VIN+ subtracting the input voltage VIN−. Two terminals of the load 103 have a voltage difference being equal to the voltage VBUS+ subtracting the voltage VBUS−.

In some embodiments, a positive terminal of the input power source 101 is coupled to a terminal of the inductor L1, a negative terminal of the input power source 101 is coupled to a node N3. A terminal of the inductor L1 is coupled to the positive terminal of the input power source 101, the other terminal of the inductor L1 is coupled to a node N1. A terminal of the capacitor C1 is coupled to the node N1, the other terminal of the capacitor C1 is coupled to the node N3. The node N3 is coupled to the negative terminal of the input power source 101. A terminal of the inductor L2 is coupled to the node N1, the other terminal of the inductor L2 is coupled to a node N2. A terminal of the capacitor C2 is coupled to a node N4, the other terminal of the capacitor C2 is coupled to a node N5. Wherein the node N2 is electrically connected to the node N4, and the node N5 is electrically connected to the node N3.

In some embodiments, a terminal of the capacitor C_BUS is coupled to the node N2, the other terminal of the capacitor C_BUS is coupled to the node N6. A terminal of the resistor PTC is coupled to a node N6, the other terminal of the resistor PTC is coupled to the node N3. A drain terminal of the switch S is coupled to the node N6, a source terminal of the switch S is coupled to the node N3. A gate terminal of the switch S is configured to receive a control signal CONT, and the switch S is turned on or turned off according to the control signal CONT.

In some embodiments, the arrangement of the power protecting device 100 can be including an absorber circuit 102_1. A terminal of the absorber circuit 102_1 is coupled to the node N2, the other terminal of the absorber circuit 102_1 is coupled to the node N3.

In some other embodiments, the arrangement of the power protecting device 100 can be including an absorber circuit 102_2. A terminal of the absorber circuit 102_2 is coupled to the node N6, the other terminal of the absorber circuit 102_2 is coupled to the node N3.

In some embodiments, the switch S can be implemented Metal Oxide Semiconductor Field-Effect Transistor(MOSFET). In some embodiments of the present disclosure, the switch S can be implemented by N type MOSFET.

In some embodiments, the capacitor C1 can be implemented by Electro-Magnetic Interference(EMI) filtering capacitor, but the present disclosure is not limited to this type of capacitor.

In some embodiments, the capacitor C2 can be implemented by high frequency filtering capacitor, but the present disclosure is not limited to this type of capacitor.

In some embodiments, the capacitor C_BUS can be implemented by Electrolytic Capacitor, but the present disclosure is not limited to this type of capacitor.

In some embodiments, the resistor PTC can be implemented by Positive Temperature Coefficient Thermistor, but the present disclosure is not limited to this type of resistor.

In some embodiments, the resistor PTC can also be implemented by Voltage Dependent Resistor(VDR), but the present disclosure is not limited to this type of resistor.

In some approaches, during an early stage of powering up an electric power system, an inrush current, generated by an energy storing capacitor when it is being charged, can be higher than a rated current that an input power source of the electric power system can afford, which causes damage or an overloading of the input power source. As a result, a power converting device applied in the electric power system requires an inrush current clamping circuit to stabilize the input current. In addition, an induced voltage generated from the resonance of capacitors and inductors can be higher than a rated voltage that a load of the electric power system can afford, which causes damage of the load or the electric power system. Therefore, the power converting device applied in the electric power system requires a transient voltage clamping circuit to stabilize the input voltage.

In the approaches discussed above, the arrangement of the inrush current limitation circuit includes a topology of stringing a powering switch into an input line, also called Stringing-into-input-line circuit, and a topology of stringing a powering switch to the bus energy storing capacitor, also called In-series-with-BUS-E-Caps circuit. In Stringing-into-input-line circuit, after the powering switch is turned on, the interior resistance of the powering switch causes excessive power consumption, and when the powering switch is turned off, the voltages between the cathode of the input side and the cathode of the bus side of the electric power system could have a high voltage difference, which easily causes damage of the powering switch. In In-series-with-BUS-E-Caps circuit, during an early stage when the input power source 101 is enabled to provide power to the electric power system, the powering switch S must be turned off at this moment in order to prevent a high inrush current generated from rapid charging of the bus capacitor, such that the bus capacitor is forced to be charged through the resistor and is placed in a high resistance path. As a result, the transient voltage clamping capability of the electric power system is lost. The In-series-with-BUS-E-Caps circuit is unable to effectively suppress the transient voltage surge on the bus, so the power converting device and the load are no longer being protected.

Compare to the approaches discussed above, in some embodiments of the present disclosure, the power protecting device 100 is able to suppress the transient voltage surge by coupling the absorber circuit 102_1 and/or the absorber circuit 102_2 between the input power source 101 and the load 103. When the input power source 101 is enabled to provide power to the electric power system, the capacitors of the absorber circuit 102_1 and/or the absorber circuit 102_2 absorb the resonant energy, caused by the resonance of an input capacitor and an inductor during the early stage of powering up the electric power system, to suppress the transient voltage surge and provide voltage clamping protection. In view of this, the In-series-with-BUS-E-Caps topology with absorber circuit 102_1 and/or absorber circuit 102_2 can be adopted to effectively suppress the transient voltage surge, and amends the disadvantage for the transient voltage suppress of the In-series-with-BUS-E-Caps topology alone. In addition, since the powering switch is not stringed into the input line in this topology, the power consumption caused by the current flowing through the circuit is lower compared to the Stringing-into-input-line topology when the power switch being turned on, which promotes the power converting efficiency.

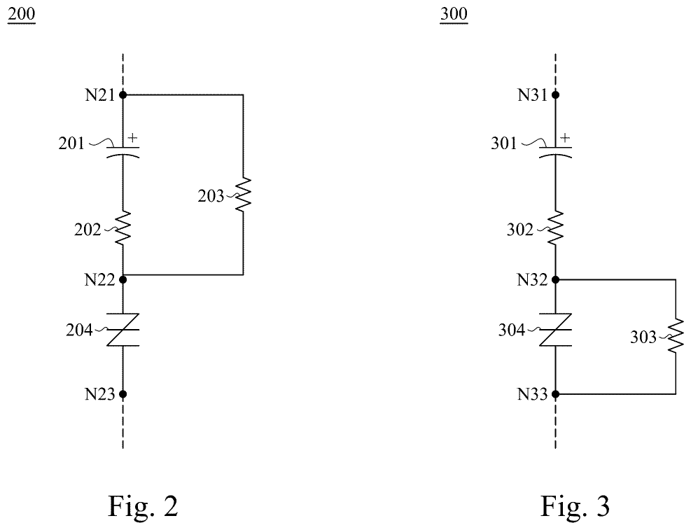

FIG. 2 is a circuit diagram of an absorber circuit 200, illustrated in accordance with some embodiments of the present disclosure. The absorber circuit 200 illustrates an embodiment of the absorber circuits 102_1 and 102_2 of the power protecting device 100 shown in FIG. 1. Alternatively stated, in some embodiments, the absorber circuits 102_1 and/or 102_2 can be implemented by the absorber circuit 200. As shown in FIG. 2, the absorber circuit 200 includes a capacitor 201, resistors 202 and 203, and a switch 204.

In some embodiments, a terminal of the capacitor 201 is coupled to a terminal of the resistor 202, the other terminal of the capacitor 201 is coupled to a node N21, and the other terminal of the resistor 202 is coupled to a node N22. Two terminal of the resistor 203 are coupled to the nodes N21 and N22, respectively. A terminal of the switch 204 is coupled to the node N22, the other terminal of the switch 204 is coupled to a node N23.

In some embodiments, when the absorber circuit 102_1 is implemented by the absorber circuit 200, the nodes N21 and N23 are respectively connected to the nodes N2 and N3 of the power protecting device 100 in FIG. 1. In some other embodiments, when the absorber circuit 102_2 is implemented by the absorber circuit 200, the nodes N21 and N23 are respectively connected to the nodes N6 and N3 of the power protecting device 100 in FIG. 1.

In some embodiments, the resistor 202 indicates an equivalent resistor of the capacitor 201 connected in series. In some embodiments, the resistor 203 is parallel connected to the capacitor 201.

FIG. 3 is a circuit diagram of the absorber circuit 300, illustrated in accordance with some embodiments of the present disclosure. The absorber circuit 300 illustrates another embodiment of the absorber circuits 102_1 and 102_2 of the power protecting device 100 shown in FIG. 1. Alternatively stated, in some embodiments, the absorber circuits 102_1 and/or 102_2 can be implemented by the absorber circuit 300. As shown in FIG. 3, the absorber circuit 300 includes a capacitor 301, resistors 302 and 303, and a switch 304.

In some embodiments, a terminal of the capacitor 301 is coupled to a terminal of the resistor 302, the other terminal of the capacitor 301 is coupled to a node N31, and the other terminal of the resistor 302 is coupled to a node N32. Two terminals of the resistor 303 are coupled to the nodes N32 and N33, respectively. A terminal of the switch 304 is coupled to the node N32, the other terminal of the switch 304 is coupled to the node N33.

In some embodiments, when the absorber circuit 102_1 is implemented by the absorber circuit 300, the nodes N31 and N33 are respectively connected to the node N2 and N3 of the power protecting device 100 shown in FIG. 1. In some other embodiments, when the absorber circuit 102_2 is implemented by the absorber circuit 300, the nodes N31 and N33 are respectively connected to the nodes N6 and N3 of the power protecting device 100 shown in FIG. 1.

In some embodiments, the resistor 302 indicates an equivalent resistor of the capacitor 301 connected in series. In some embodiments, the resistor 303 is parallel connected to the switch 304.

In some embodiments, each of the switch 204 in the absorber circuit 200 and the switch 304 in the absorber circuit 300 can be implemented by Thyristor, configured to control the absorber circuits 200 and 300, but the present disclosure is not limited to this type of switch.

In some embodiments, each of the capacitor 201 in the absorber circuit 200 and the capacitor 301 in the absorber circuit 300 is configured to absorb energy to stabilize the voltage to which the absorber circuit is coupled. Each of the capacitors 201 and 301 can be implemented by an Electrolytic Capacitor, but the present disclosure is not limited to this type of capacitor.

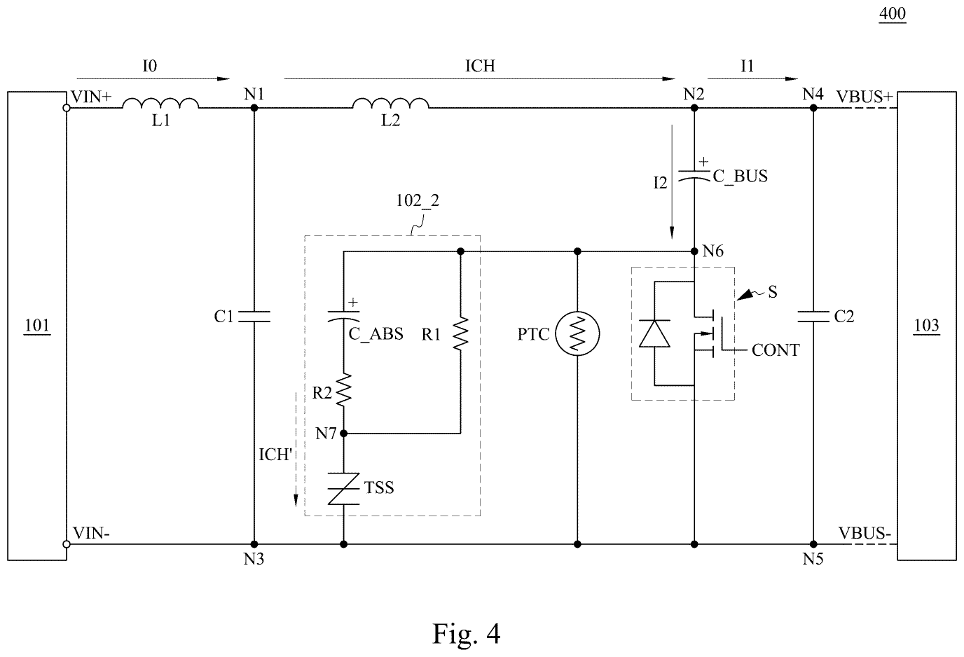

FIG. 4 is a circuit diagram of the power protecting device 400, illustrated in accordance with some embodiments of the present disclosure. The power protecting device 400 is an embodiment of the power protecting device 100 as shown in FIG. 1, and the arrangement of the power protecting device 400 includes the absorber circuit 102_2. As shown in FIG. 4, the power protecting device 400 includes the input power source 101, the absorber circuit 102_2, the load 103, the resistor PTC, the inductance L1, the inductance L2, the switch S, the capacitors C1, C2 and C_BUS of the power protecting device 100. The absorber circuit 102_2 includes a capacitor C_ABS, a switch TSS, and resistors R1 and R2.

Referring to FIG. 2, FIG. 3, and FIG. 4, the capacitor C_ABS in the absorber circuit 102_2 corresponds to the capacitor 201 in the absorber circuit 200 and the capacitor 301 in the absorber circuit 300. The switch TSS in the absorber circuit 102_2 corresponds to the switch 204 in the absorber circuit 200 and the switch 304 in the absorber circuit 300. The functionality of the resistor R1 in the absorber circuit 102_2 corresponds to each of the functionality of the resistor 203 in the absorber circuit 200 and the functionality of the resistor 303 in the absorber circuit 300. The functionality of the resistor R2 in the absorber circuit 102_2 corresponds to each of the functionality of the resistor 202 in the absorber circuit 200 and the functionality of the resistor 302 in the absorber circuit 300.

Referring to FIG. 4 FIG. 1, in the absorber circuit 102_2 of FIG. 4, a terminal of the capacitor C_ABS is coupled to the node N6, the other terminal of the capacitor C_ABS is coupled to a terminal of the resistor R2, and the other terminal of the resistor R2 is coupled to the node N7. A terminal of the resistor R1 is coupled to the node N6, the other terminal of the resistor R1 is coupled to the node N7. A terminal of the switch TSS is coupled to the node N7, the other terminal of the switch TSS is coupled to the node N3.

In some embodiments, the coupling relationship between elements in the power protecting device 400 is similar to the power protecting device 100, the similarity between the power protecting devices 400 and 100 is not repeated herein for simplicity. The power protecting device 400 is discussed to demonstrate the embodiments of the present disclosure hereafter.

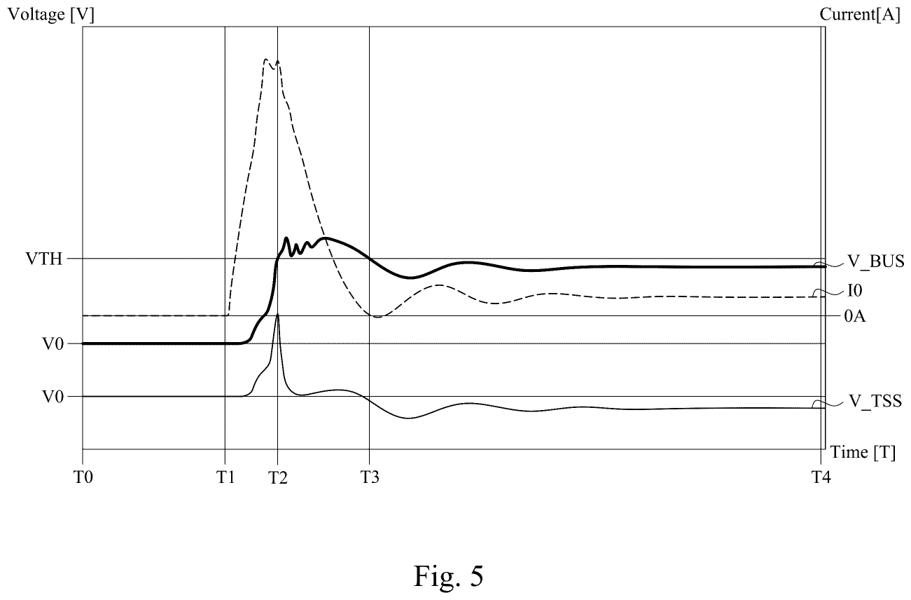

FIG. 5 is a timing diagram 500 of operating the power protecting device 400, illustrated in accordance with some embodiments of the present disclosure. As show in FIG. 5, the timing diagram 500 illustrates the operation of the power protecting device 400 during a period between time T0 and time T4.

Referring to FIG. 4 and FIG. 5, the timing diagram 500 illustrates the change of the voltage signal V_BUS at the node N4, a current signal I0 flowing through the node N1, and the voltage signal V_TSS of the switch TSS with respect to time.

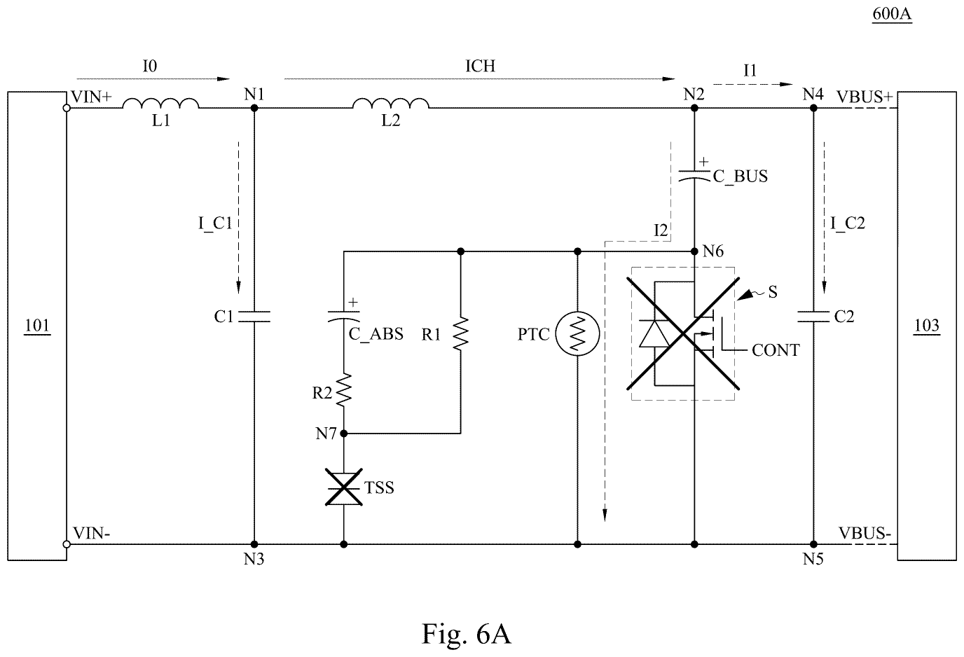

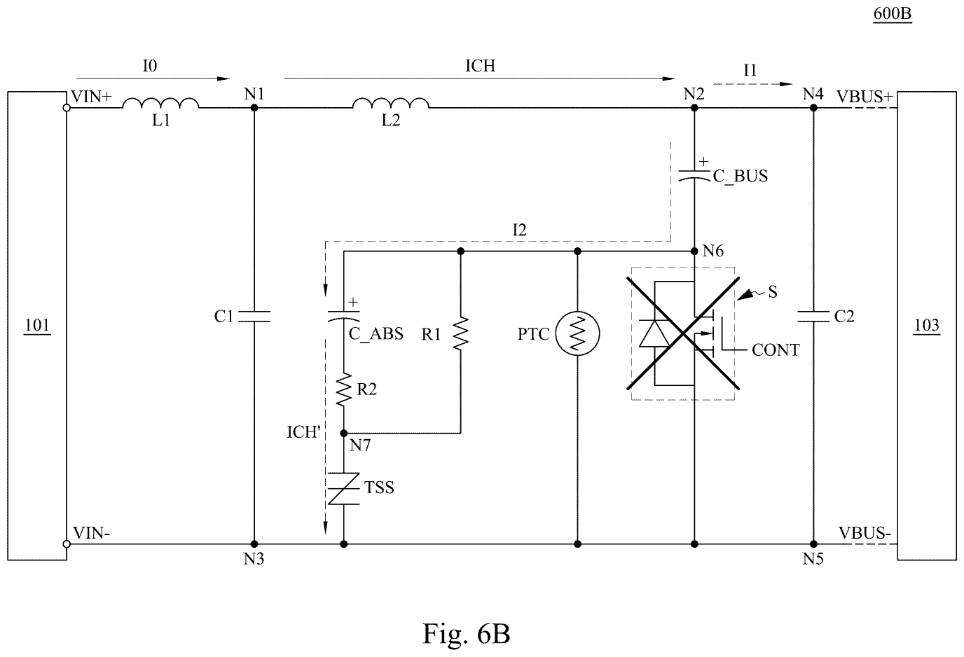

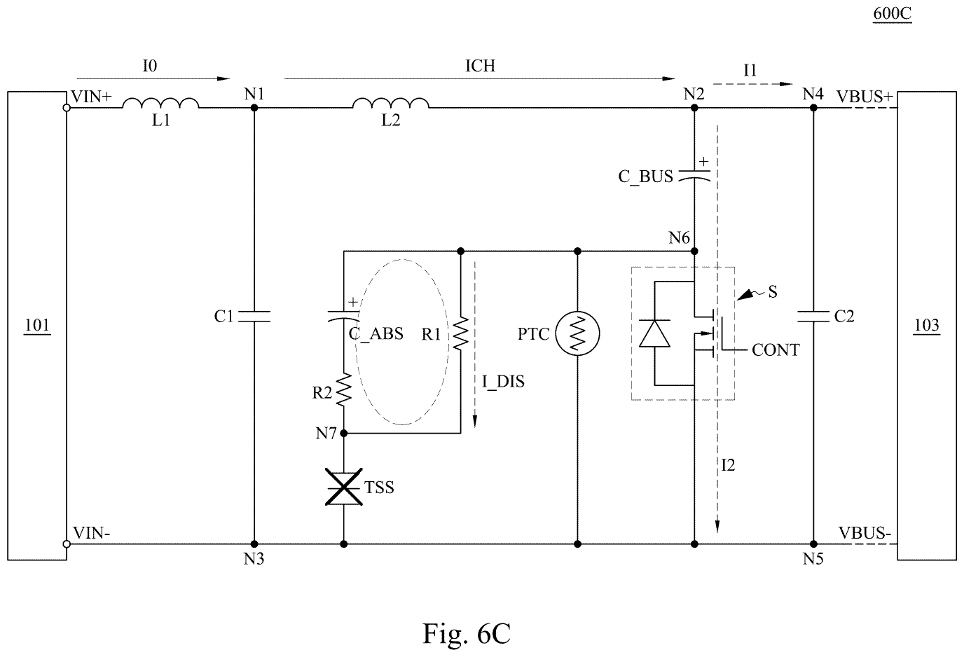

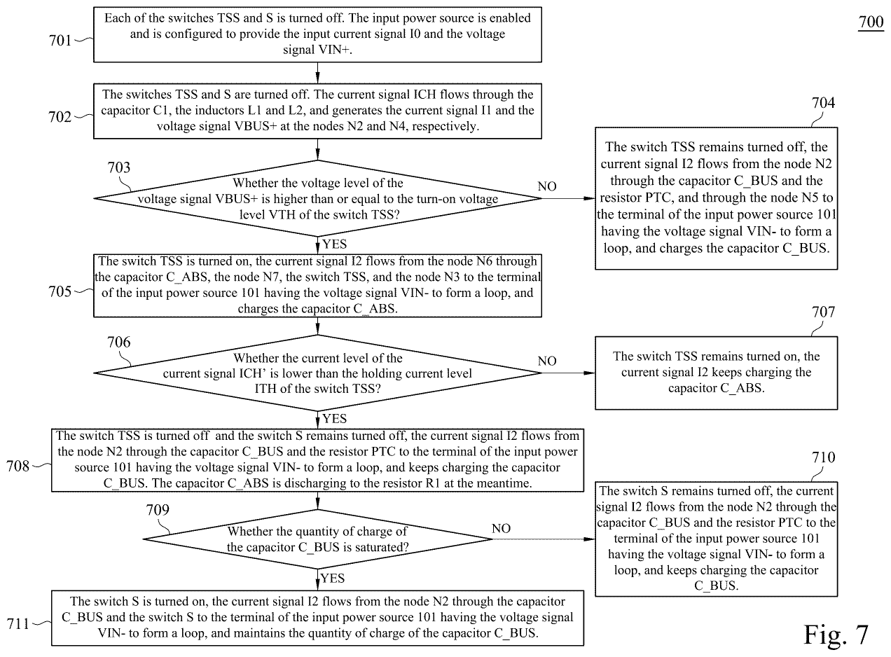

In some embodiments, when the input power source 101 starts to provide power, the input power source 101 is configured to provide the input voltage signal VIN and the current signal ICH, and generate the voltage signal V_BUS at the node N4. The current signal ICH is divided at the node N2, and generates a current signals I1 and I2. The current signal I1 flows from the node N2 to the node N4. The current signal I2 flows from the node N2 through the capacitor C_BUS to the node N6, and generates a current signal ICH′ flowing through the switch TSS when the switch TSS is turned on. When the switch TSS is turned off, the two terminals of the switch TSS has a voltage signal V_TSS. Further details regarding the operation of the power protecting 400 and the change of the current signals I0, I1, I2, ICH, ICH′ and the voltage signals V_BUS and V_TSS with respect to time are discussed in the following FIG. 6A to FIG. 6C and FIG. 7.

In some embodiments, the voltage signal V_BUS indicates an absolute value of the voltage difference between the voltage signals VBUS+ and VBUS−. For example, when the voltage signal VBUS+ has a voltage level of 80 volt, and the voltage signal VBUS− has a voltage level of minus 80 volt, the voltage signal V_BUS has a voltage level of 160 volt.

In some embodiments, the input voltage signal VIN indicates the absolute value of the voltage difference between the input voltage signals VIN+ and VIN−. For example, when the input voltage signal VIN+ has a voltage level of 60 volt, and the input voltage signal VIN− has a voltage level of minus 60 volt, the voltage signal VIN has a voltage level of 120 volt.

FIG. 6A to FIG. 6C are circuit diagrams of operating the power protecting device 400 during a period in the timing diagram 500 of FIG. 5, illustrated in accordance with some embodiments of the present disclosure. FIG. 6A corresponds to a period between time T0 and time T2. FIG. 6B corresponds to a period between time T2 and time T3. FIG. 6C corresponds to the time after time T3.

Referring to FIG. 5 and FIG. 6A, during a period between time T0 and T2, each of the switches TSS and S remains turned off.

During the period between time T0 and T1, the input power source 101 is in a disabled status. Each of the voltage signals V_BUS and V_TSS has a voltage level V0, and the current signal I0 in the power protecting device 400 has a current level of 0 ampere. Wherein the voltage level V0 is configured to indicate a turn-off voltage level of a device.

During the period between time T1 and T2, the input power source 101 is enabled. Since each of the capacitors C1, C2, and C_BUS in the circuit is uncharged, the input power source 101 is configured to provide the input voltage VIN, such that an energy is generated to charge each of the capacitors C1, C2, and C_BUS, and respectively generates the current signals I_C1, I_C2, and I2. The current signals I0, ICH, and I1 are also generated to transmit energy to two terminals of the load 103, so as to generate the voltage signals V_BUS. Wherein since the transient change rate of the capacitors I_C1 and I_C2 is relatively high, the induced voltage signals V_L1 and V_L2 is generated on the inductors L1 and L2, respectively, which causes the capacitors C1 and C2 and the inductors L1 and L2 to resonance, resulting in voltage fluctuations of the voltage signal V_BUS.

In some embodiments, when the voltage level of the voltage signal VBUS+ is lower than a turn-on voltage level VTH of the switch TSS, the switch TSS is turned off. In response to the switch TSS being turned off, the current signal I2 is not charging the capacitor C_ABS of the absorber circuit 102_2. At this moment, a terminal of the switch TSS has a voltage level being the same as the voltage level of the voltage signal VBUS+. In response to the switch S being turned off, the current signal I2 is charging the capacitor C_BUS through the resistor PTC.

Referring to FIG. 5 and FIG. 6B, during the period between time T2 and T3, the voltage level of the voltage signal VBUS+ is higher than or equal to the turn-on voltage level VTH of the switch TSS as a result of the voltage fluctuations from the resonance of the inductors and the capacitors, such that the switch TSS is turned on. In response to the switch TSS being turned on, and since the switch S remaining turned off, the current signal I2 flows from the capacitor C_BUS through the node N6 to the capacitor C_ABS to charge the capacitor C_ABS. the capacitor C_ABS has the capability of absorbing the resonance energy, and helps stabilizing the voltage signal V_BUS.

In some embodiments, when the switch TSS is turned on, the switch TSS is configured to provide a low impedance path for the current signals ICH and I2 that charging the capacitor C_ABS by the current signal ICH′ to absorb the overvoltage caused by the resonance to keep the voltage signal V_BUS at the node N4 stabilized.

In some embodiments, the turn-on voltage level VTH is higher than the voltage level of the input voltage VIN and a voltage level of a BUS voltage signal V_TOL when the load 103 is in a steady state. For example, when the input voltage VIN has a voltage level of 80 volt, the turn-on voltage level VTH can be set to 90 volt. At this moment, when the BUS voltage signal V_TOL is higher than or equal to a voltage level of 90 volt, the absorber circuit 102_2 is configured to suppress the extent of increasing of the voltage signal V_BUS as the voltage signal V_BUS has increased to a voltage level that is higher than or equal to the turn-on voltage level VTH, such that the voltage signal V_BUS has been clamped to not surpass a specific voltage level.

Referring to FIG. 5, FIG. 6B, and FIG. 6C, during the period between times T2 and T3, the current signal I2 is configured to charge the capacitor C_ABS and generate the current signal ICH′ that flows out from the capacitor C_ABS. The current signal ICH′ flows from the capacitor C_ABS through the resistor R2 to the node N7, then flows from the node N7 through the switch TSS to the node N3.

At this moment, in response to the current signal I2 constantly charging the capacitor C_ABS, the quantity of charge of the capacitor C_ABS gradually becomes saturated, and the current level of the current signal ICH′ remain decreasing. In some embodiments, when the current level of the current signal ICH′ is decreased to be lower than a holding current level ITH of the switch TSS, the switch TSS is turned off.

After time T3, when the current level of the decreasing current signal ICH′ is decreased to be lower than the holding current level ITH, the switch TSS is turned off. In response to the switch TSS being turned off, the current signal I2 stops charging the capacitor C_ABS. At this moment, the voltage level of the voltage signal V_BUS has reached a steady state.

Then, the absorber circuit (such as 102_2) performs a self-recovering process. Specifically, when the quantity of charge of the capacitor C_ABS after being charged is saturated, the capacitor C_ABS is discharging to the resistor R1, and generates a discharging current signal I_DIS. As the current level of the discharge current signal I_DIS decreases gradually, the quantity of charge of the capacitor C_ABS is approaching zero, the absorber circuit (such as 102_2) completes the self-recovering process and recover to the status as in FIG. 6A.

In some embodiments, the operation of turning off the switches TSS and turning on the switch S can also be operated after time T4. Alternatively stated, the operation of the power protecting device 400 can be operated after the status of time T4 of the timing diagram 500 in FIG. 5.

In some embodiments, when the switch TSS has been turned off, the current signal I2 remains charging the capacitor C_BUS through the path of the resistor PTC until the quantity of charge of the capacitor C_BUS is approximately saturated. Then, the switch S is configured to receive a control signal CONT, such that the switch S is turned on. When the switch S is turned on, the current signal I2 flows from the node N2 to the capacitor C_BUS, and then flows from the capacitor C_BUS through the switch S to the node N3. The switch S provides a lower resistant path for the current signal I2 which flowed through the capacitor C_BUS to reduce power consumption.

FIG. 7 is a flow chart diagram of a control process 700 controlling a power protecting device, illustrated in accordance with some embodiments of the present disclosure. As shown in FIG. 7, the control process 700 includes operations 701-711. In some embodiments, the control process 700 can be applied to the power protecting devices 100 and 400. The power protecting device 400 is adopted hereafter to demonstrate the control process 700 as an embodiment of the disclosure.

Referring to FIG. 7 and FIG. 5, the operations 701 and 702 correspond to the period between time T0 and T2 in FIG. 5. The operations 703 and 704 correspond to time T2 in FIG. 5. The operation 705 corresponds to the period between time T2 and T3 in FIG. 5. The operation 706-711 correspond to the timing after time T3 in FIG. 5.

At the operation 701, each of the switches TSS and S is turned off. The input power source 101 is enabled to provide the input current signal I0 and the input voltage signal VIN+.

Specifically, the input power source 101 provides current signal and/or voltage signal to each of the elements of the circuit. The power protecting device 400 continue to perform the operation 702 after the operation 701 is performed.

At the operation 702, each of the switches TSS and S is turned off. The current signal I0 is divided and generates the current signal ICH at the node N1 after the current signal I0 flowed through the inductor L1. The current signal ICH is divided at the node N2 after the current signal ICH flowed through the inductor L2.

Specifically, the current signal ICH flows through the inductor L2, and generates the voltage signal VBUS+ at the node N2, and generates the current signal I1 flowing trough the node N4 and the current signal I2 flowing through the capacitor C_BUS. Wherein the node N4 connected to the node N2 has the voltage signal VBUS+ similar o the node N2, and also has the voltage level of the voltage signal VBUS+.

In response to the current signals I0 and/or ICH flowing through each of the inductors L1, L2, and the capacitor C1, the current signal I1 and the voltage signal VBUS+ keep increasing. In response to the switch TSS being turned off, the voltage level of the voltage signal TSS measured by the switch TSS keeps increasing. The power protecting device 400 continue to perform the operation 703 after the operation 702 is performed.

At the operation 703, the power protecting device 400 determines whether the voltage level of the voltage signal VBUS+ is higher than or equal to the turn-on voltage level VTH of the switch TSS.

Specifically, the absorber circuit 102_2 determines whether the voltage level of the voltage signal VBUS+ is increased to be higher than or equal to the turn-on voltage level of the switch TSS. When the voltage level of the voltage signal VBUS+ has increased to be higher than or equal to the turn-on voltage level VTH of the switch TSS, the power protecting device 400 continues to perform the operation 705 after the operation 703 is performed. When the voltage level of the voltage signal VBUS+ has not increased to be higher than or equal to the turn-on voltage level VTH of the switch TSS, the power protecting device 400 continues to perform the operation 704 after the operation 703 is performed.

At the operation 704, when the voltage level of the voltage signal V_BUS+is not higher than or equal to the turn-on voltage level VTH of the switch, the switch TSS remains turned off. At this moment, the current signal I2 flows from the node N2 through the capacitor C_BUS, the resistor PTC, and the node N5 to a terminal of the input power source 101 having the voltage signal VIN− to form a loop, and charges the capacitor C_BUS.

At the operation 705, when the voltage level of the voltage signal VBUS+ is higher than or equal to the turn-on voltage level VTH of the switch TSS, the switch TSS is turned on.

Specifically, when the switch TSS is turned on, the current signal I2 flows form the node N6 through the capacitor C_ABS, the node N7, the switch TSS, and the node N3 to a terminal of the input power source 101 having the voltage signal VIN− to form a loop, and charges the capacitor C_ABS. In response to the current signal I2 charging the capacitor C_ABS, the current signal I2 generates the current signal ICH′ flowing through the capacitor C_ABS. The power protecting device 400 continues to perform the operation 706 after the operation 705 is performed.

In some embodiments, when current signal I2 is charging the capacitor C_ABS, the quantity of charge of the capacitor C_ABS is increased correspondingly. In response to the quantity of charge of the capacitor C_ABS being increased, the current level of the current signal ICH′ is decreased correspondingly.

At the operation 706, the power protecting device 400 determines whether the current level of the current signal ICH′ is lower than the holding current level ITH of the switch TSS.

Specifically, the absorber circuit 102_2 determines whether the current level of the current signal ICH′ keeps decreasing to be lower than the holding current level ITH of the switch TSS. When the current level of the current signal ICH′ has not decreased to be lower than the holding current level ITH of the switch TSS, the power protecting device 400 continues to perform the operation 707 after the operation 706 is performed. When the current level of the current signal ICH′ has decreased to be lower than the holding current level ITH of the switch TSS, the power protecting device 400 continues to perform the operation 708 after the operation 706 is performed.

At the operation 707, the switch TSS remains turned on, the current signal I2 keeps charging the capacitor C_ABS. The quantity of charge of the capacitor C_ABS keeps increasing, and the current level of the current signal ICH′ keeps decreasing.

At the operation 708, the switch TSS is turned off and the switch S remains turned off, the current signal I2 flows from the node N2 through the capacitor C_BUS and the resistor PTC to a terminal of the input power source 101 having the voltage signal VIN−, and keeps charging the capacitor C_BUS. In the meantime, the capacitor C_ABS is discharging to the resistor R1. The power protecting device 400 continues to perform the operation 709 after the operation 708 is performed.

Specifically, when the switch TSS is turned off, the path formed by the capacitor C_ABS and the node N2 becomes open. The current signal I2 can only form a loop through the path of the resistor PTC to a terminal of the input power source 101 having the voltage signal VIN− to keep charging the capacitor C_BUS. At the meantime, the charged capacitor C_ABS is discharging to the resistor R1. In response to the capacitor C_ABS discharging to the resistor R1, the quantity of charge of the capacitor C_ABS is decreasing correspondingly. When the capacitor has discharged, the capacitor C_ABS is recovered to the initial status before being charged. The power protecting device 400 continues to perform the operation 709 after the operation 708 is performed.

At the operation 709, the power protecting device 400 determines whether the quantity of charge of the capacitor C_BUS is saturated.

Specifically, as the current signal I2 remains charging the capacitor C_BUS, the quantity of charge of the capacitor C_BUS keeps increasing until the capacitor C_BUS is saturated. When the capacitor C_BUS has not saturated, the power protecting device 400 continues to perform the operation 710 after the operation 709 is performed. When the capacitor C_BUS has saturated, the power protecting device 400 continues to perform the operation 711 after the operation 709 is performed.

At the operation 710, the switch S remains turned off, the current signal I2 flows from the node N2 through the capacitor C_BUS and the resistor PTC to a terminal of the input power source 101 having the voltage signal VIN− to form a loop, and keeps charging to the capacitor C_BUS.

At the operation 711, the switch S is turned on, the current signal I2 flows from the node N2 through the capacitor C_BUS and the switch S to a terminal of the input power source 101 having the voltage signal VIN− to form a loop, and maintains the quantity of charge of the capacitor C_BUS. The power protecting device 400 completes the control process 700 after the operation 711 is performed.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A power protecting device, comprising:
an input power source coupled to a first capacitor at a first node, and configured to provide an input voltage signal;
a first switch coupled to the first capacitor;
a first resistor coupled to the first capacitor, and connected to the first switch in parallel; and
an absorber circuit coupled to the first node, or coupled to the first node through the first capacitor,
wherein, the absorber circuit is coupled between the input power source and the first switch, and the absorber circuit is connected in parallel with each of the first switch and the first resistor, or
the absorber circuit is coupled to the first capacitor, two terminals of the first switch and two terminals of the first resistor, and the absorber circuit is connected in parallel with a combo of the first capacitor, the first switch, and the first resistor.

2. The power protecting device of claim 1, wherein the absorber circuit includes:
a second capacitor coupled to a second resistor; and
a second switch coupled to the second capacitor,
wherein the second capacitor is coupled to the first node, or is coupled to the first node through the first capacitor.

3. The power protecting device of claim 2, wherein
when a voltage level of a voltage signal at the first node is higher than a turn-on voltage level of the second switch, the second switch is turned on, and
wherein the turn-on voltage level is higher than a voltage level of the input voltage signal.

4. The power protecting device of claim 2, wherein
the input power source is configured to provide a first current signal, the first current signal flows through each of the first node and the first capacitor and generates a second current signal, and
wherein when the second switch is turned on, and when a current level of the second current signal is lower than a holding current level of the second switch, the second switch is turned off.

5. The power protecting device of claim 4, wherein
when the second switch is turned on, the first current signal is configured to charge the first capacitor, and generates the second current signal.

6. The power protecting device of claim 2, wherein
when the second switch is turned off, the second capacitor is configured to discharge to the second resistor.

7. The power protecting device of claim 4, wherein
when the current level of the second current signal is lower than the holding current level of the second switch, and after the second switch is turned off, the first switch is turned on, and
wherein when the first switch is turned on, the first current signal is configured to maintain a quantity of charge of the first capacitor.

8. The power protecting device of claim 4, wherein
when the second switch has turned off, the second current signal charges the first capacitor through the first resistor until a quantity of charge of the first capacitor is saturated.

9. The power protecting device of claim 4, further comprising:
a first inductor coupled to the input power source;
a second inductor coupled to the first inductor and coupled to the first capacitor at the first node; and
a third capacitor coupled to each of the first inductor and the second inductor.

10. The power protecting device of claim 9, wherein
the input power source is configured to provide an input current signal,
the input current signal flows through each of the first inductor and the second inductor to generate the first current signal at the first node.

11. The power protecting device of claim 10, wherein in response to the input current signal flowing through each of the first inductor and the second inductor, each of the first current signal and a voltage level of a voltage signal at the first node is increasing.

12. A method for controlling a power protecting device, comprising:
coupling a first capacitor to an input power source at a first node;
coupling a first switch to the first capacitor;
when a voltage level of a voltage signal at the first node is higher than or equal to a turn-on voltage level of a second switch, turning on the second switch; and
when the second switch is turned on, and when a current level of a second current signal flowed through the second switch is lower than a holding current level, turning off the second switch,
wherein the input power source is configured to provide a first current signal, the first current signal flows through each of the first node and the first capacitor.

13. The method of claim 12, further comprising:
when the second switch is turned on, charging a second capacitor by the second current signal; and
when the second switch is turned off, discharging to a second resistor by the second capacitor,
wherein the second capacitor is coupled to the second switch, and the second resistor is coupled to the second switch and connected in parallel with the second capacitor or the second switch.

14. The method of claim 12, wherein
when the current level of the second current signal is lower than the holding current level of the second switch, and when the second switch has turned off, turning on the first switch, and
when the first switch is turned on, the first current signal is configured to maintain a quantity of charge of the first capacitor.

15. The method of claim 12, wherein
the input power source is further configured to provide an input voltage signal to each of the first node and the first capacitor, and
the turn-on voltage level of the second switch is higher than a voltage level of the input voltage signal.

16. The method of claim 13, further comprising:
coupling an absorber circuit between the input power source and the first switch; and
coupling a first resistor to the first capacitor, and connecting to the first switch in parallel,
wherein the absorber circuit is connected in parallel with each of the first switch and the first resistor.

17. The method of claim 16, wherein
the absorber circuit is coupled to the first node, or coupled to the first node through the first capacitor, and
the absorber circuit comprises each of the second capacitor and the second switch.

18. The method of claim 16, wherein
when the second switch has turned off, the second current signal charges the first capacitor through the first resistor until a quantity of charge of the first capacitor is saturated.

19. The method of claim 12, wherein
the input power source is further configured to provide an input current signal,
the input current signal flows through each of a first inductor and a second inductor to generate the first current signal at the first node,
the first inductor is coupled to the input power source, and
the second inductor is coupled to the first inductor and is coupled to the first capacitor at the first node.

20. The method of claim 19, wherein in response to the input current signal flowing through each of the first inductor and the second inductor, the each of the first current signal and a voltage level of a voltage signal at the first node is increasing.
